(19) United States
(12) Patent Application Publication
(10) Pub. No.: US 2026/0188966 A1
(43) Pub. Date: Jul. 2, 2026

(54) APPARATUSES AND METHODS FOR A COMPACT, LOW PHASE NOISE TUNABLE RADIO FREQUENCY SYNTHESIZER

(71) Applicant: Honeywell International Inc., Charlotte, NC (US)

(72) Inventors: Matthew Wade Puckett, Phoenix, AZ (US); Chad Hoyt, Roseville, MN (US); Jianfeng Wu, Tucson, AZ (US); Karl D. Nelson, Plymouth, MN (US); Wei Charles Jiang, Vestal, NY (US)

(73) Assignee: Honeywell International Inc., Charlotte, NC (US)

(21) Appl. No.: 19/008,079

(22) Filed: Jan. 2, 2025

(51) Int. Cl. H01S 3/102; H01S 3/23; H01S 3/30

(52) U.S. Cl. CPC H01S 3/1028; H01S 3/2391; H01S 3/30

(57) ABSTRACT

A frequency of a first injection locked laser and a passband spectrum of a first optical filter coupled to the first injection locked laser are adjusted to overlap. Optionally, a frequency of a second injection locked laser and a passband spectrum of a second optical filter coupled to the second injection locked laser are adjusted to overlap. Such adjustments are made so that a stimulated Brillouin scattering (SBS) resonator emits a first SBS optical signal, derived from a first optical signal emitted from the first injection locked laser, and a second SBS optical signal, derived from a second optical signal emitted from the second injection locked laser. By mixing the first and the second SBS optical signals, a mixing product is generated with a desired carrier wave that is equal to a difference between the carrier wave frequencies of the first and the second SBS optical signals.

### STATEMENT REGARDING FEDERALLY SPONSORED RESEARCH OR DEVELOPMENT

This invention was made with Government support under Contract No. HR0011-22-C-0018 awarded by DARPA. The Government has certain rights in the invention.

### BACKGROUND

A tunable radio frequency (RF) synthesizer, which emits a signal with lower phase noise, has broad applicability for sensing, metrology, and telecommunications. However, such an RF synthesizer with diminished phase noise also undesirably has increased size, weight, power consumption, and/or cost.

### SUMMARY

In some aspects, the techniques described herein relate to a method for generating a desired frequency of a radio frequency (RF) signal with diminished phase noise, the method including: receiving data indicative of the desired frequency of the RF signal; using the data indicative of the desired frequency, determining a third carrier wave frequency and a fourth carrier wave frequency which when mixed generate a mixing product at the desired frequency, wherein each of the third and the fourth carrier wave frequencies is selected from a set of stimulated Brillouin scattering (SBS) optical frequencies at which an SBS optical resonator is configured to generate an optical signal; using the third carrier wave frequency, adjusting a carrier wave frequency of a first optical signal, configured to be emitted by a first frequency tunable laser, to be a first carrier wave frequency and/or using the fourth carrier wave frequency, adjusting a carrier wave frequency of a second optical signal, configured to be emitted by a second frequency tunable laser, to be equal to a second carrier wave frequency; using the third carrier wave frequency, adjusting a first passband spectrum to include the first carrier wave frequency and/or using the fourth carrier wave frequency, adjusting a second passband spectrum to include the second carrier wave frequency; after adjusting the first carrier wave frequency and/or the second carrier wave frequency, and after adjusting the first passband spectrum and/or after adjusting the second passband spectrum, then emitting the first optical signal with the first carrier wave frequency from the first frequency tunable laser and emitting the second optical signal with the second carrier wave frequency from the second frequency tunable laser; receiving, at the SBS optical resonator, the first optical signal through the first passband spectrum and the second optical signal through the second passband spectrum; emitting from the SBS optical resonator, a first SBS optical signal, a second SBS optical signal, a portion of the first optical signal, and a portion of the second optical signal; receiving, the portion of the first optical signal, through the first passband spectrum and at the first frequency tunable laser injection locking the first frequency tunable laser; receiving, the portion of the second optical signal, through the second passband spectrum and at the second frequency tunable laser injection locking the second frequency tunable laser; and using the first SBS optical signal and the second SBS optical signal, generating the mixing product at the desired frequency.

In some aspects, the techniques described herein relate to a radio frequency (RF) synthesizer configured to generate a desired frequency of an RF signal with diminished phase noise, the RF synthesizer including: a processing circuit configured to receive data indicative of the desired frequency of the RF signal, to determine a third carrier wave frequency and a fourth carrier wave frequency which when mixed generate a mixing product at the desired frequency, using the third carrier wave frequency, to generate a first control signal with a parameter value and a third control signal with a parameter value, and using the fourth carrier wave frequency, to generate a second control signal with a parameter value and a fourth control signal with a parameter value, wherein each of the third and the fourth carrier wave frequencies is selected from a set of stimulated Brillouin scattering (SBS) optical frequencies at which an SBS optical resonator is configured to generate an optical signal; a first frequency tunable laser configured to emit a first optical signal at a first carrier wave frequency determined by the parameter value of the first control signal; a second frequency tunable laser configured to emit a second optical signal, at a second carrier wave frequency determined by the parameter value of the second control signal; a first frequency tunable optical filter configured to receive the first optical signal, wherein a first passband spectrum of the first frequency tunable optical filter is configured to be set, by the parameter value of the third control signal, to include the first carrier wave frequency; a second frequency tunable optical filter configured to receive the second optical signal, wherein a second passband spectrum of the second frequency tunable optical filter is configured to be set, by the parameter value of the fourth control signal, to include the second carrier wave frequency; the SBS optical resonator configured to receive the first optical signal having the first carrier wave frequency and the second optical signal having the second carrier wave frequency and to emit a portion of the first optical signal having the first carrier wave frequency, a portion of the second optical signal having the second carrier wave frequency, a first SBS optical signal having the third carrier wave frequency, and a second SBS optical signal having the fourth carrier wave frequency; wherein the first frequency tunable laser is further configured to receive, through the first frequency tunable optical filter, the portion of the first optical signal having the first carrier wave frequency and to be injection locked; wherein the second frequency tunable laser is further configured to receive, through the second frequency tunable optical filter, the portion of the second optical signal having the second carrier wave frequency and to be injection locked; and an optical mixer configured to generate, using the first SBS optical signal and the second SBS optical signal, generating the mixing product at the desired frequency.

In some aspects, the techniques described herein relate to a method of calibrating a radio frequency (RF) signal which includes a processing circuit configured to receive data indicative of a desired frequency of the RF signal, to determine a third carrier wave frequency and a fourth carrier wave frequency which when mixed generate a mixing product at the desired frequency, using the third carrier wave frequency, to generate a first control signal with a parameter value and a third control signal with a parameter value, and using the fourth carrier wave frequency, to generate a second control signal with a parameter value and a fourth control signal with a parameter value, wherein each of the third and the fourth carrier wave frequencies is selected from a set of stimulated Brillouin scattering (SBS) optical frequencies at which an SBS optical resonator is configured to generate an optical signal; a first frequency tunable laser configured to emit a first optical signal at a first carrier wave frequency determined by the parameter value of the first control signal; a second frequency tunable laser configured to emit a second optical signal, at a second carrier wave frequency determined by the parameter value of the second control signal; a first frequency tunable optical filter configured to receive the first optical signal, wherein a first passband spectrum of the first frequency tunable optical filter is configured to be set, by the parameter value of the third control signal, to include the first carrier wave frequency; a second frequency tunable optical filter configured to receive the second optical signal, wherein a second passband spectrum of the second frequency tunable optical filter is configured to be set, by the parameter value of the fourth control signal, to include the second carrier wave frequency; the SBS optical resonator configured to receive the first optical signal having the first carrier wave frequency and the second optical signal having the second carrier wave frequency and to emit a portion of the first optical signal having the first carrier wave frequency, a portion of the second optical signal having the second carrier wave frequency, a first SBS optical signal having the third carrier wave frequency, and a second SBS optical signal having the fourth carrier wave frequency; wherein the first frequency tunable laser is further configured to receive, through the first frequency tunable optical filter, the portion of the first optical signal having the first carrier wave frequency and to be injection locked; wherein the second frequency tunable laser is further configured to receive, through the second frequency tunable optical filter, the portion of the second optical signal having the second carrier wave frequency and to be injection locked; and an optical mixer configured to generate, using the first SBS optical signal and the second SBS optical signal, generating the mixing product at the desired frequency, the method including: determining a first trio relationship; determining a second trio relationship; storing the first and the second trio relationships; and wherein the first trio relationship includes a parameter value of each of the first control signal and the third control signal, and the third carrier wave frequency of the first SBS optical signal configured to be emitted by the SBS optical resonator when such parameter value of the first control signal is conveyed to the first frequency tunable laser and when such parameter value of the third control signal is conveyed to the first frequency tunable optical filter; wherein the second trio relationship includes a parameter value of each of the second control signal and the fourth control signal, and the fourth carrier wave frequency of the second SBS optical signal configured to be emitted by the SBS optical resonator when such parameter value of the second control signal is conveyed to the second frequency tunable laser and when such parameter value of the fourth control signal is conveyed to the second frequency tunable optical filter.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIG. 1A illustrates a block diagram of one embodiment of a radio frequency synthesizer configured to generate a radio frequency signal with diminished phase noise at a desired frequency;

FIG. 1B illustrates a diagram of one embodiment of a frequency spectrum of the SBS optical resonator;

FIG. 1C illustrates a diagram of one embodiment of a first passband spectrum of the first frequency tunable optical filter and a second passband spectrum of the second frequency tunable optical filter;

FIG. 2A illustrates a plan view of one embodiment of a frequency tunable four port optical filter;

FIG. 2B illustrates a cross sectional diagram of one embodiment of a planar optical waveguide of the frequency tunable four port optical filter illustrated in FIG. 2A;

FIG. 3 illustrates a plan view of one embodiment of an SBS optical resonator;

FIG. 4 illustrates one embodiment of a method of generating a radio frequency signal with diminished phase noise at a desired frequency;

FIG. 5 illustrates a block diagram of one embodiment of an apparatus to calibrate a radio frequency synthesizer; and

FIG. 6 illustrates one embodiment of a method of calibrating a radio frequency synthesizer according to embodiments of the invention.

In accordance with common practice, the various described features are not drawn to scale but are drawn to emphasize specific features relevant to the exemplary embodiments. Reference characters denote like elements throughout figures and text.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that structural, mechanical, and electrical changes may be made. Furthermore, the method presented in the drawing figures and the specification is not to be construed as limiting the order in which the individual steps may be performed. The following detailed description is, therefore, not to be taken in a limiting sense.

Embodiments of the invention are an RF synthesizer with both lower phase noise and lower size, weight, power consumption, and/or cost than a conventional RF synthesizer with diminished phase noise. The RF synthesizer is configured to generate an RF frequency output signal with a programmable frequency. The RF synthesizer utilizes two injection locked, frequency tunable lasers to generate two optical pump signals. Each optical pump signal has diminished phase noise due to the invention locking of each of the two frequency tunable lasers. The frequency of each of the two diminished phase noise optical pump signals is selected to generate two stimulated Brillouin scattering (SBS) optical signals in an SBS optical resonator. A difference of the frequency of each of the SBS optical signals equals a desired frequency of the RF signal output from the RF synthesizer. Such desired output frequency may be programmed or entered by a user and/or another component. The output RF signal with the desired frequency is derived by mixing the two SBS optical signals.

Each SBS optical signal has inherently lower phase noise than the optical pump signal which gives rise to the SBS optical signal. Thus, the phase noise of each SBS optical signal is even lower than the phase noise of the optical pump signal generated by injection locking of the frequency tunable laser. with the programmed frequency also has very low phase noise.

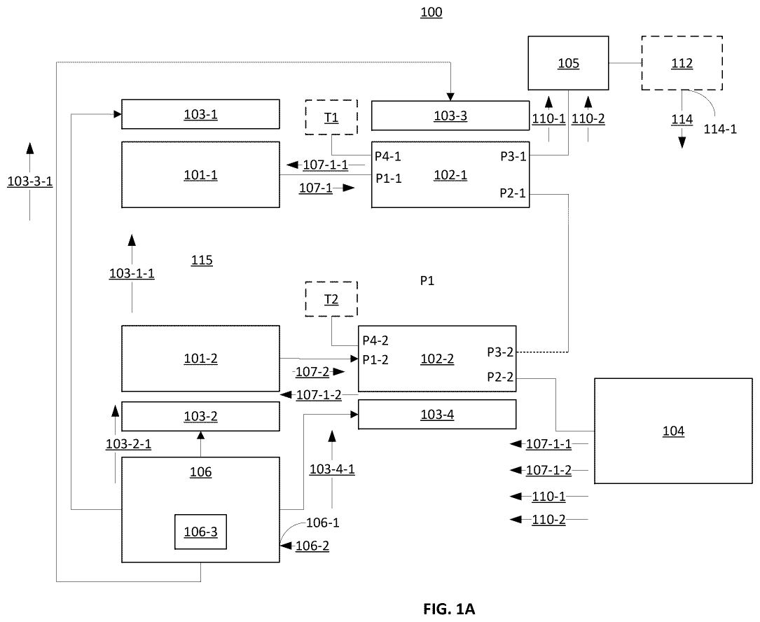

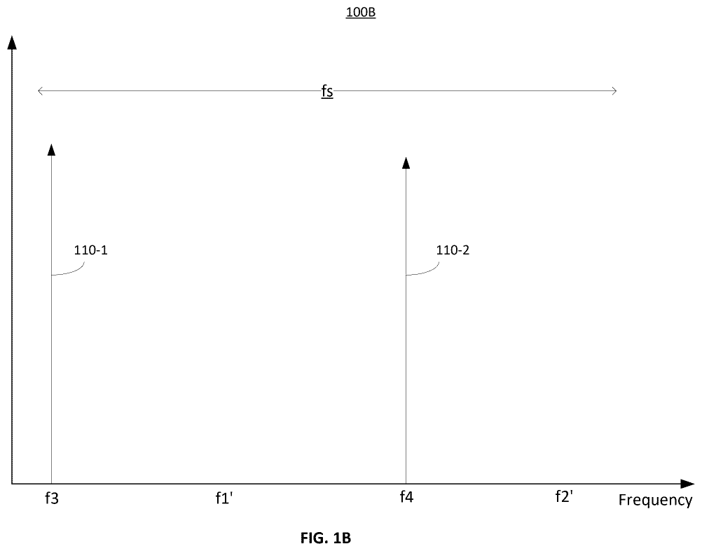

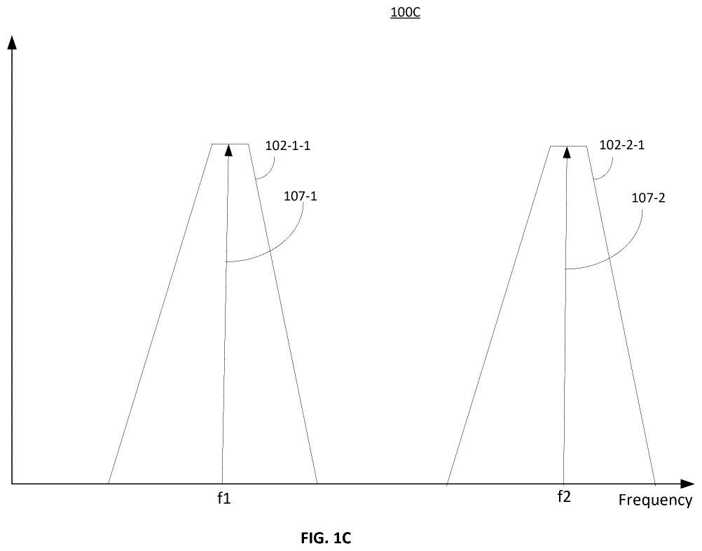

FIG. 1A illustrates a block diagram of one embodiment of a radio frequency synthesizer 100 configured to generate a radio frequency signal with diminished phase noise at a desired frequency. For pedagogical purposes, embodiments of the invention are illustrated herein using temperature (or temperature changes) to adjust a frequency of an optical signal emitted by a frequency tunable laser and to adjust a passband spectrum of a frequency tunable optical filter. However, the frequency of the optical signal emitted by a frequency tunable laser and the passband frequency of a frequency tunable optical filter may be controlled in other ways. For pedagogical purposes, embodiments of the invention are illustrated herein using temperature (or temperature changes) to adjust each of the frequency of the optical signal emitted by the frequency tunable laser and the passband spectrum of the frequency tunable optical filter. However, the frequency of such optical signal emitted by the frequency tunable laser and the passband spectrum of the frequency tunable optical filter may be controlled in other ways. For example, such control may use a voltage (or a varying voltage) (e.g., a frequency tunable laser or optical filter implemented with a micro-electro-mechanical system), using an electric field (or a varying electric field) (e.g., a laser made with material with electro-optic properties, a liquid crystal tunable filter, or a filter made with a material with electro optic properties), or with sound waves (or varying sound waves) (e.g., a laser with an acousto-optic modulator or acousto-optic tunable filter. Thus, embodiments of the invention are not limited to techniques using of temperature or temperature variation.

The RF synthesizer 100 includes a first laser configured to have a tunable output frequency (or first frequency tunable laser) 101-1, a second laser configured to have a tunable output frequency (or second frequency tunable laser) 101-2, a first optical filter with a tunable passband frequency (or first frequency tunable optical filter or a first frequency tunable optical filter circuit) 102-1, a second optical filter with a tunable passband frequency (or a second frequency tunable optical filter or a second frequency tunable optical filter circuit) 102-2, a first heater and/or cooler (or a first heater and/or cooler circuit) 103-1, a second heater and/or cooler (or a second heater and/or cooler circuit) 103-2, a third heater and/or cooler (or a third heater and/or cooler circuit) 103-3, a fourth heater and/or cooler 103-4 (or a fourth heater and/or cooler circuit), an SBS optical resonator 104, an optical mixer (or optical mixing circuit) 105 and a processing system (or processing circuitry) 106. Optionally, the RF synthesizer 100 includes a filter (or an RF filter, a filter circuit, or an RF filter circuit) 112.

Optionally, the first frequency tunable optical filter 102-1, the second frequency tunable optical filter circuit 102-2, the first heater and/or cooler 103-1, the second heater and/or cooler 103-2, the third heater and/or cooler 103-3, the fourth heater and/or cooler 103-4, and the SBS optical resonator 104 are each on a substrate 115. Optionally, first frequency tunable laser 101-1, the second frequency tunable laser 101-2, the processing system 106, the optical mixer 105, and/or the optional RF filter 112 are on the substrate 115. Optionally, the substrate 115 is an insulator, for example, a semiconductor, e.g., undoped silicon.

Each heater and/or cooler described herein may be a resistive heater or any other type of heater and/or any type of cooler (e.g., a thermoelectric cooler). Optionally, the processing system 106 includes processor circuitry communicatively coupled to memory circuitry.

Optionally, the first frequency tunable laser 101-1 is optically coupled to the first frequency tunable optical filter 102-1, e.g., the first port P1-1 thereof, by optical waveguide, e.g., optical fiber or planar optical waveguide. Optionally, the second frequency tunable laser 101-2 is optically coupled to the second frequency tunable optical filter 102-2, e.g., the first port P1-2 thereof, by optical waveguide, e.g., optical fiber or planar optical waveguide.

The processing system 106 includes a frequency data input 106-1 configured to receive data indicative of a desired frequency 106-2 of an RF signal to be emitted by the RF synthesizer 100. FIG. 1A illustrates a diagram 100B of signals utilized by embodiments of the invention. Such signals are hereinafter discussed.

Using the desired frequency 106-2, the processing system 106 is configured to select a third carrier wave frequency f3 of a first SBS optical signal 110-1 and a fourth carrier wave frequency f4 of a second SBS optical signal 110-2. A difference, i.e., the absolute value of difference, between the selected third carrier wave frequency and the selected fourth carrier wave frequency is the desired frequency 106-2 of the RF signal.

Optionally, the third carrier wave frequency and the fourth carrier wave frequency are each selected from a set, of SBS optical frequencies at which the SBS optical resonator is configured to generate an optical signal, or a representation of the set, e.g., stored in a processing system (for example in translational data stored therein) or in another system. Alternatively, such set of SBS optical frequencies is extracted from one or both trio relationships described elsewhere herein. Optionally, such trio relationships may be a set or function(s). Such trio relationships are illustrated for pedagogical purposes; embodiments of the invention may use other ways of storing the third and the fourth carrier wave frequencies, the relationship of the third carrier wave frequencies and the first and the third control signal parameter values, and the relationship of the fourth carrier wave frequencies and the second and the fourth control signal parameter values

FIG. 1B illustrates a diagram 100B of one embodiment of a frequency spectrum fs of the SBS optical resonator 104. The illustrated frequency spectrum fs of the SBS optical resonator 104 includes a first resonant frequency f1′, a second resonant frequency f2′, a third resonant frequency f3, and a fourth resonant frequency f4. As discussed elsewhere herein, a first SBS optical signal 110-1 is generated at the third resonant frequency f3 and a second SBS optical signal 110-2 is generated at the fourth resonant frequency f4.

The processing system 106 is also configured to select the first carrier wave frequency f1 so that the first pump optical signal 107-1 at the first carrier wave frequency f1 generates, in the SBS optical resonator 104, stimulated Brillouin scattering in a third resonant frequency f3 of the SBS optical resonator 104; as a result, a first SBS optical signal 110-1, with a third carrier wave frequency equal to the third resonant frequency f3, is generated by and emitted from the SBS optical resonator 104. The processing system 106 is also configured to select the second carrier wave frequency f2 so that the second pump optical signal 107-2 at the second carrier wave frequency f2 generates, in the BS optical resonator 104, stimulated Brillouin scattering in a fourth resonant frequency f4 of the SBS optical resonator 104; as a result, a second SBS optical signal 110-2, with a fourth carrier wave frequency equal to the fourth resonant frequency f4, is generated by and emitted from the SBS optical resonator 104

The processing system 106 is further configured to cause the first frequency tunable laser 101-1 to emit the first pump optical signal 107-1 with the first carrier wave frequency f1; e.g., the processing system 106 is configured to adjust a carrier wave frequency, of the first pump optical signal 107-1 to be the first carrier wave frequency f1.

FIG. 1C illustrates a diagram 100C of one embodiment of a first passband spectrum 102-1-1 of the first frequency tunable optical filter 102-1 and a second passband spectrum 102-2-1 of the second frequency tunable optical filter 102-2. Returning to FIG. 1A, the processing system 106 is also configured to cause a first passband spectrum 102-1-1, e.g., a center frequency thereof, of the first frequency tunable optical filter 102-1 to be tuned to the first carrier wave frequency f1. Thus, the first pump optical signal 107-1 can be conveyed from a first port P1-1 of the first frequency tunable optical filter 102-1 to a second port P2-1 of the first frequency tunable optical filter 102-1.

The processing system 106 is further configured to cause the second frequency tunable laser 101-2 to emit the second pump optical signal 107-2 with the second carrier wave frequency f2; e.g., the processing system 106 is configured to adjust a carrier wave frequency, of the second pump optical signal 107-2 to be the second carrier wave frequency f2. The processing system is also configured to cause a second passband spectrum 102-2-1, e.g., a center frequency thereof, of the second frequency tunable optical filter 102-2 to be tuned to the second carrier wave frequency f2. Thus, the second pump optical signal 107-2 can be conveyed from a first port P1-2 of the second frequency tunable optical filter 102-2 to a second port P2-2 of the second frequency tunable optical filter 102-2.

The processing system 106 causes the first frequency tunable laser 101-1 to emit the first pump optical signal 107-1 at the first carrier wave frequency f1 by adjusting a temperature of the first frequency tunable laser 101-1. To do so, the processing system 106 adjusts an amount of heat emitted from or drawn to the first heater and/or cooler 103-1 by sending a signal, e.g., an electrical signal, to the first heater and/or cooler 103-1. The first heater and/or cooler 103-1 is adjacent to the first frequency tunable laser 101-1 so that it can control a temperature of the first frequency tunable laser 101-1. By varying a temperature of the first frequency tunable laser 101-1, an index of refraction of the first frequency tunable laser 101-1 is changed. Because the index of refraction of the first frequency tunable laser 101-1 varies with temperature, by changing the temperature varying index of refraction of the first frequency tunable laser 101-1, the frequency of the first pump optical signal 107-1 emitted by the first frequency tunable laser 101-1 may be adjusted.

The processing system 106 causes the second frequency tunable laser 101-2 to emit the second pump optical signal 107-2 at the second carrier wave frequency f2 by adjusting a temperature of the second frequency tunable laser 101-2. To do so, the processing system 106 adjusts an amount of heat emitted from or drawn to the second heater and/or cooler 103-2 by sending a signal, e.g., an electrical signal, to the second heater and/or cooler 103-1. The second heater and/or cooler 103-2 is adjacent to the second frequency tunable laser 101-2 so that it can control a temperature of the second frequency tunable laser 101-2. By varying a temperature of the second frequency tunable laser 101-2, an index of refraction of the second frequency tunable laser 101-2 is changed. Because the index of refraction of the second frequency tunable laser 101-2 varies with temperature, by changing the temperature varying index of refraction of the second frequency tunable laser 101-2, the frequency of the second pump optical signal 107-2 emitted by the second frequency tunable laser 101-2 may be adjusted.

Optionally, the processing system 106 may only have to adjust a temperature of one of the first and the second frequency tunable lasers 101-1, 101-2. Thus, the processing system 106 would only have to adjust the heat emitted from or drawn to either the first or the second heater and/or cooler 103-1, 103-2.

Optionally, the processing system 106 includes translational data 106-3 configured to perform the aforementioned functions. The processing system 106, e.g., the translational data 106-3, includes two trio relationships. A first trio relationhsip includes a parameter value of each of the first control signal 103-1-1 and the third control signal 103-3-1, and a third carrier wave frequency configured to be emitted by the first frequency tunable laser 101-1 and propagated through the first frequency tunable optical filter 102-1 when such parameter value of the first control signal is conveyed to the first frequency tunable laser and when such parameter value of the third control signal is conveyed to the first frequency tunable optical filter. The second trio relationship includes a parameter value of each of the second control signal 103-3-1 and the fourth control signal 103-4-1, and a fourth carrier wave frequency configured to be emitted by the second frequency tunable laser 101-2 and propagated through the second frequency tunable optical filter 102-2 when such parameter value of the second control signal is conveyed to the second frequency tunable laser and when such parameter value of the fourth control signal is conveyed to the second frequency tunable optical filter. Each of the trio relationships may be stored as equation(s), data sets, look up table(s), database(s), or any other technique for performing the aforementioned functions.

The processing system 106 is coupled to the first heater and/or cooler 103-1 and the second heater and/or cooler 103-2. The processing system 106 is also configured to transmit a first heater and/or cooler control signal 103-1-1 to the first heater and/or cooler 103-1 to adjust (based on a parameter value of the first heater and/or cooler control signal) an amount of heat emitted by or drawn to the first heater and/or cooler 103-1. The processing system is configured to transmit a second heater and/or cooler control signal 103-2-1 to the second heater and/or cooler 103-2 to adjust (based on a parameter value of the second heater and/or cooler control signal) an amount of heat emitted by or drawn to the second heater and/or cooler 103-2.

Based on the temperature of the first frequency tunable laser 101-1 affected by the first heater and/or cooler 103-1, the first frequency tunable laser 101-1 is configured emit the first pump optical signal 107-1 with the first carrier wave frequency f1 equal to the first resonant frequency f1′ of the SBS optical resonator 104. Based on the temperature of the second frequency tunable laser 101-2 affected by the second heater and/or cooler 103-2, the second frequency tunable laser 101-2 is configured to emit the second pump optical signal 107-2 with the second carrier wave frequency f2 equal to the second resonant frequency f2′ of the SBS optical resonator 104.

The first frequency tunable optical filter 102-1 is optically coupled to an output of the first frequency tunable laser 101-1, and is configured to receive the first pump optical signal 107-1. The second frequency tunable optical filter 102-2 is optically coupled to an output of the second frequency tunable laser 101-2, and is configured to receive the second pump optical signal 107-2.

Optionally, each of the first and the second frequency tunable optical filters 102-1, 102-2 is a four port optical filter. For pedagogical purposes, FIG. 1A illustrates that each of the first and the second frequency tunable optical filters 102-1, 102-2 is a four port frequency tunable optical filter. However, in other embodiments, each frequency tunable optical filter may be implemented with other components, e.g., a two port frequency tunable optical filter and one or more optical components, e.g., optical coupler(s), optical divider/combiner(s), and/or any other type of optical component.

The first frequency tunable optical filter 102-1 includes a first port P1-1, a second port P2-1, a third port P3-1, and a fourth port P4-1. The second frequency tunable optical filter 102-2 includes a first port P1-2, a second port P2-2, a third port P3-2, and a fourth port P4-2.

When an optical signal provided to a first port P1-1, P1-2 is within a passband 102-1-1, 102-2-1 of a frequency tunable optical filter 102-1, 102-2, then the optical signal is coupled to and emitted from the second port P2-1, P2-1. When the optical signal is provided the first port P 1-1, P 1-2 is not within a passband 102-1-1, 102-2-1 of a frequency tunable optical filter 102-1, 102-2, then the optical signal is conveyed to the fourth port P4-1, P4-2. Optionally, each fourth port P4-1, P4-2 may be terminated with an optical termination T1, T2 which absorbs and/or emits any optical signal (out of a passband 102-1-1, 102-2-1 of the four port optical filter) conveyed to a fourth port P4-1, P4-2.

The processing system 106 is also coupled to the third heater and/or cooler 103-3 and the fourth heater and/or cooler 103-4. The processing system 106 is also configured to transmit a third heater and/or cooler control signal 103-3-1 to the third heater and/or cooler 103-1 to adjust (based on a parameter value of the third heater and/or cooler control signal) an amount of heat emitted by or drawn to the third heater and/or cooler 103-3. The processing system is configured to transmit a fourth heater and/or cooler control signal 103-4-1 to the fourth heater and/or cooler 103-4 to adjust (based on a parameter value of the fourth heater and/or cooler control signal) an amount of heat emitted by or drawn to the fourth heater and/or cooler 103-4.

Based on the temperature of the first frequency tunable optical filter 102-1 affected by the third heater and/or cooler 103-3, the second frequency tunable optical filter 102-2 is configured to have the first passband spectrum 102-1-1 encompassing, e.g., centered around, the first carrier wave frequency f1, e.g., the first resonant frequency f1′. Based on the temperature of the second frequency tunable optical filter 102-1 affected by the fourth heater and/or cooler 103-4, the second frequency tunable optical filter 102-2 is configured have the second passband spectrum 102-2-1 encompassing, e.g., centered around, the second carrier wave frequency f2, e.g., the second resonant frequency f2′. As a result, the first pump optical signal 107-1 is coupled from the first port P1-1 to the second port P2-1 of the first frequency tunable optical filter 102-1, and is emitted from such second port P2-1 of the first frequency tunable optical filter 102-1. As a result, the second pump optical signal 107-2 is coupled from the first port P1-2 to the second port P2-2 of the second frequency tunable optical filter 102-2, and is emitted from such second port P2-2 of the second frequency tunable optical filter 102-2.

Optionally, as with the first and the second frequency tunable lasers 101-1, 101-2, the processing system 106 may only have to adjust a temperature of one of the first and the second frequency tunable optical filters 102-1, 102-2. Thus, the processing system 106 would only have to adjust the heat emitted from or drawn to either the third or the fourth heater and/or cooler 103-3, 103-4.

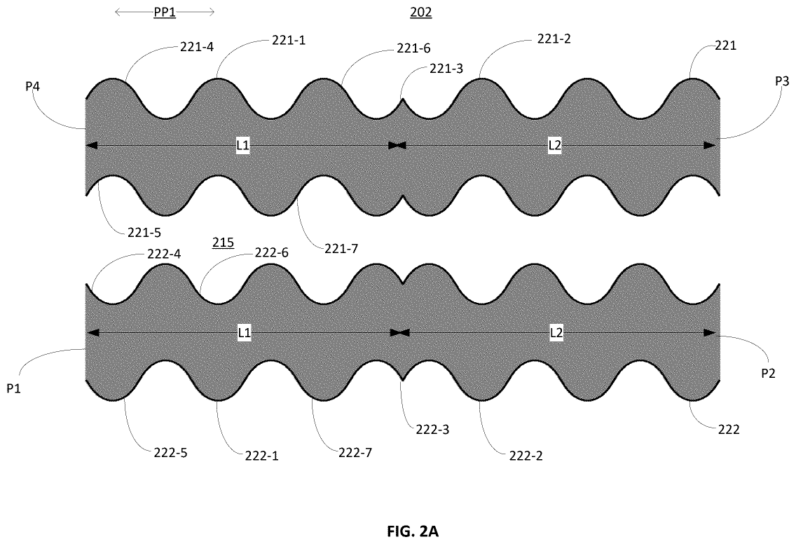

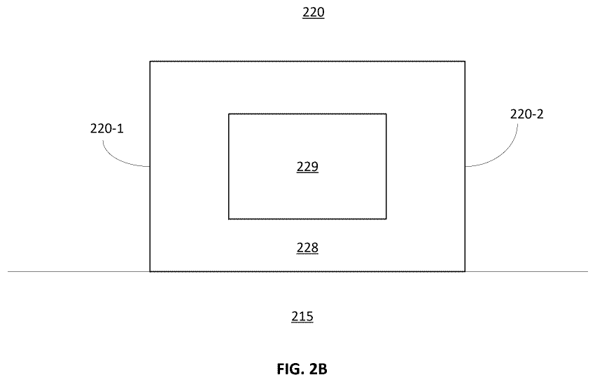

FIG. 2A illustrates a plan view of one embodiment of a frequency tunable four port optical filter 202. The frequency tunable four port optical filter 202 can be implemented in other ways other than the embodiment illustrated in FIG. 2A. The frequency tunable four port optical filter 202 of FIG. 2A is shown only for pedagogical purposes.

The frequency tunable four port optical filter 202 includes a first planar optical waveguide 221 and a second planar optical waveguide 222. Each planar optical waveguide 221, 222 is on a substrate 215, e.g., an insulator for example an undoped semiconductor, e.g., silicon. The first planar optical waveguide 221 includes a first portion 221-1 optically coupled to a second portion 221-2 by a one hundred and eighty degree phase shift 221-3. The second planar optical waveguide 221 also includes a first portion 222-1 optically coupled to a second portion 222-2 by a one hundred and eighty degree phase shift 222-3. The first planar optical waveguide 221 includes a first sidewall 221-4 with a periodic grating 221-6 and a second sidewall 221-5 with a periodic grating 221-7. The second planar optical waveguide 222 includes a first sidewall 222-4 with a periodic grating 222-6 and a second sidewall 222-5 with a periodic grating 222-7. Optionally, a grating period PP1 of the periodic grating 221-6 is identical for each side wall of each portion of each of the first and the second planar optical waveguides 221, 222; however, alternatively the grating period PP1 may vary by sidewall, by portion, or by planar optical waveguide. The grating period(s) establishes the passband, e.g., the center frequency, of the frequency tunable four port optical filter 202.

Optionally, each first portion 221-1, 222-1 and each second portion 222-2, 222-2 have an equal length L1, L2. For pedagogical purposes, this is what is illustrated in FIG. 2A. However, the lengths L1, L2 of the first and the second portions 221-1, 221-2, 222-1, 222-2 of the planar optical waveguide 221, 222 need not be equal.

The frequency tunable four port optical filter 202 has a first port P1, a second port P2, a third port P3, and a fourth port P4. If a signal injected into one port, e.g., the first port P1, of a planar optical waveguide of the frequency tunable four port optical filter, has a carrier wave frequency within a passband spectrum of the planar optical waveguide, then the signal is emitted from the other port of the planar optical waveguide, e.g. the second port. If a signal injected into the one port, e.g., the first port P1, of the planar optical waveguide of the frequency tunable four port optical filter, has the carrier wave frequency not within the passband spectrum of the planar optical waveguide, then the signal is emitted from a port, adjacent to the one port, of the other planar optical waveguide, e.g. the fourth port P4.

FIG. 2B illustrates a cross sectional diagram of one embodiment of a planar optical waveguide 220 of the frequency tunable four port optical filter 202 illustrated in FIG. 2A. The planar optical waveguide 220 includes a core 229 surrounded by cladding 228. The cladding 228, and hence the core 229, are over the substrate 215. The core 229 has an index of refraction greater than the index of refraction of the cladding 228. Optionally, the core 229 includes silicon nitride and the cladding 228 includes silicon dioxide. The planar optical waveguide 220 has a first sidewall 220-1 opposite a second sidewall 220-2; a periodic grating is formed in each sidewall 220-1, 220-2.

Returning to FIG. 1A, when the second passband spectrum 102-2-1, e.g., the center frequency thereof, of the second frequency tunable optical filter 102-2 is adjusted so that the second carrier wave frequency f2 of the second pump optical signal 107-2 is substantially within the second passband spectrum 102-2-1, e.g., substantially equal to the center frequency of the second passband spectrum, then the second pump optical signal 107-2 propagates from, e.g., the second port P2-2 of, the second frequency tunable optical filter 102-2 to the SBS optical resonator 104. Optionally, the second frequency tunable optical filter 102-2, e.g., the second port P2-2 thereof, is optically coupled to the SBS optical resonator 104 by optical waveguide, e.g., optical fiber or planar optical waveguide.

When the first passband spectrum 102-1-1, e.g., the center frequency thereof, of the first frequency tunable optical filter 102-1 is adjusted so that the first carrier wave frequency f1 of the first pump optical signal 107-1 is substantially within the first passband spectrum 102-1-1, e.g., substantially equal to the center frequency thereof, then the first pump optical signal 107-1 propagates from, e.g., the second port P2-1 of, the first frequency tunable optical filter 102-1 to, e.g., the third port P3-2 of, the second frequency tunable optical filter 102-2. Optionally, the first frequency tunable optical filter 102-1, e.g., the second port P2-1 thereof, is optically coupled to the second frequency tunable optical filter 102-2, e.g., the third port P3-2 thereof, by optical waveguide, e.g., optical fiber or planar optical waveguide. Because the first carrier wave frequency f1 of the first pump optical signal 107-1 is not substantially within the second passband spectrum 102-2-1, e.g., not substantially equal to the center frequency of the second passband spectrum 102-2-1, of the second frequency tunable optical filter 102-2, the first pump optical signal 107-1 is emitted from the second frequency tunable optical filter 102-2, e.g., from the second port P2-2 thereof, to the SBS optical resonator 104.

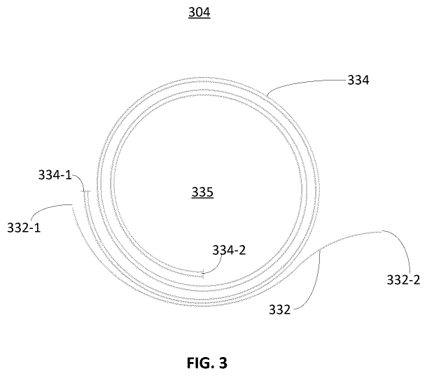

FIG. 3 illustrates a plan view of one embodiment of an SBS optical resonator 304. The SBS optical resonator 104 of FIG. 1A can be implemented in other ways other than the embodiment illustrated in FIG. 3. The SBS optical resonator of FIG. 3 is shown only for pedagogical purposes.

The illustrated SBS optical resonator 304 includes a coupling optical waveguide 332 and an optical resonator 334. Optionally, each of the coupling optical waveguide 332 and the optical resonator 334 are on a substrate 335; thus, the SBS optical resonator is on a substrate 335. The coupling optical waveguide 332 has a first coupling port 332-1 and a second coupling port 332-2. The first coupling port 332-1 is configured to be optically coupled to the second frequency tunable optical filter 102-2, e.g., the second port P2-2 thereof. Optionally, during normal operation of the radio frequency synthesizer 100, the second coupling port 332-2 is unterminated.

For pedagogical purposes, the optical resonator is illustrated as an optical waveguide, i.e., an optical waveguide resonator, which for example is coiled; however, the optical resonator 334 can be implemented with a disc, race track, ring, oval, micro-resonator, or any other type of optical resonator. The optical waveguide resonator has a first end 334-1 and a second end 334-2, and a length between the first end 334-1 and the second end 334-2. Optionally, each of the coupling optical waveguide 332 and the optical resonator 334 may be a planar optical waveguide or an optical fiber.

The dimension(s), e.g., length and/or radius, of the optical resonator 334 must be sufficient large to ensure that the free spectral range of the SBS optical resonator 304 is sufficiently small to ensure (a) that resonant frequencies of the SBS optical resonator 304 overlap with the range of tunable frequencies of each of the first and the second frequency tunable lasers 101-1, 101-2 and (b) that there are a sufficient number of stimulated Brillouin scattering gain spectral bands in the optical resonator 334 which overlap resonant frequencies of the SBS optical resonator 304 to give rise to a sufficient number of potential third carrier wave frequencies (of the first SBS optical signal 110-1) and potential fourth carrier wave frequencies (of the second SBS optical signal 110-2) whose difference mixing products include a set of desired frequencies, of an RF signal 114 configured to be emitted by the RF synthesizer 100. Optionally, the RF synthesizer 100 may be specified to generate an RF output signal with a frequency in the set of desired frequencies. The set of desired frequencies is defined by a frequency range between a lowest frequency and a highest frequency and an incremental frequency; the incremental frequency is a constant frequency value defining a frequency separation between adjacent frequencies in the set. Thus, optionally, the set may include between thousands to hundreds of millions of frequencies. The lowest frequency of the set is limited, at least in part, by the Q factor of the SBS optical resonator 304.

A carrier wave frequency of each SBS optical signal, generated in the SBS optical resonator 104, is less than the carrier wave frequency of the optical signal received by the SBS optical resonator 104 and which generates the SBS optical signal. Optionally, the carrier wave frequency of an SBS optical signal is between ten to eleven gigahertz lower in frequency then such optical signal.

The first frequency tunable laser 101-1 is configured to emit the first pump optical signal 107-1 with a power level so that when the first pump optical signal 107-1 is coupled into the optical resonator 334, that the first pump optical signal 107-1 has a power level in the optical resonator 334 which exceeds an SBS power level threshold necessary to induce the first SBS optical signal 110-1 at the third carrier wave frequency in a first SBS gain spectrum and a first resonance of the optical resonator 334; the first SBS optical signal 110-1 is derived from the first pump optical signal 107-1. The third carrier wave frequency f3 of the first SBS optical signal 110-1 is less than the first carrier frequency f1 of the first pump optical signal 107-1. A phase noise of third carrier wave frequency of the first SBS optical signal 110-1 is less than a phase noise of the first pump optical signal 107-1. The first SBS optical signal 110-1 is emitted by the SBS optical resonator 304, e.g., the first coupling port 332-1 of the coupling optical waveguide 332.

The second frequency tunable laser 101-2 is configured to emit the first pump optical signal 107-2 with a power level so that when the second pump optical signal 107-2 is coupled into the optical resonator 334, that the second pump optical signal 107-2 has a power level in the optical resonator 334 which exceeds an SBS power level threshold necessary to induce the second SBS optical signal 110-2 at the fourth third carrier wave frequency in a second SBS gain spectrum and a second resonance of the optical resonator 334; the second SBS optical signal 110-2 is derived from the second pump optical signal 107-2. The fourth carrier wave frequency f4 of the first SBS optical signal 110-1 is less than the second carrier frequency f2 of the second pump optical signal 107-2. A phase noise of the second SBS optical signal 110-2 is less than a phase noise of the second carrier frequency of the second pump optical signal 107-2. The second SBS optical signal 110-2 is emitted by the SBS optical resonator 304, e.g., the first coupling port 332-1 of the coupling optical waveguide 332.

Returning to FIG. 1A, internally, the SBS optical resonator 304, e.g., the optical resonator 334, reflects a portion 107-1-1 of the first pump optical signal 107-1 and a portion 107-2-1 of the second pump optical signal 107-2. Such portions 107-1-1, 107-2-1 are emitted by the SBS optical resonator 304, e.g., the first coupling port 332-1 of the coupling optical waveguide 332.

The second port P2-2 of the second frequency tunable optical filter is configured to receive each of the portion 107-1-1 of the first pump optical signal 107-1, the portion 107-2-1 of the second pump optical signal 107-2, the first SBS optical signal 110-1, and the second SBS optical signal 110-2.

Because the second carrier wave frequency f2 of the portion 107-2-1 of the second pump optical signal 107-2 is substantially within the passband 102-2-1, e.g., substantially equal to the center frequency of the passband 102-2-1, of the second frequency tunable optical filter 102-2, the portion 107-2-1 of the second pump optical signal 107-2 propagates through and is emitted from, e.g., the first port P1-2 of, the second frequency tunable optical filter 102-2 to the second frequency tunable laser 101-2. Receipt of the now twice filtered portion 107-2-1 of the second pump optical signal 107-2 causes the second frequency tunable laser 101-2 to become injection locked. As a result of injection locking of the second frequency tunable laser 101-2, the phase noise of the second pump optical signal 107-2 is reduced; because the phase noise of an SBS optical signal is less than the optical pump signal which generates the SBS optical signal, the phase noise of the second SBS optical signal 110-2 is also diminished due to injection locking of the second frequency tunable laser 101-2.

Because the first carrier wave frequency f1 of the portion 107-1-1 of the first pump optical signal 107-1, the third carrier wave frequency f3 of the first SBS optical signal 110-1, and the fourth carrier wave frequency f4 of the second SBS optical signal 110-2 are not within the passband 102-2-1, e.g., does not equal the center frequency thereof, of the second frequency tunable optical filter 102-2, the portion 107-1-1 of the first pump optical signal 107-1, the first SBS optical signal 110-1, and the second SBS optical signal 110-2 are reflected (or emitted) from, e.g., the third port P3-2 of, the second frequency tunable optical filter 102-2 to, e.g., a second port P2-1 of, the first frequency tunable optical filter 102-1.

Because the first carrier wave frequency f1 of the portion 107-1-1 of the first pump optical signal 107-1 is substantially within the passband 102-1-1, e.g., substantially equal to the center frequency of the passband 102-1-1, of the first frequency tunable optical filter 102-1, the portion 107-1-1 of the first pump optical signal 107-1 propagates through and is emitted from, e.g., the first port P1-1 of, the first frequency tunable optical filter 102-1 to the first frequency tunable laser 101-1. Receipt of the now twice filtered portion 107-1-1 of the first pump optical signal 107-1 causes the first frequency tunable laser 101-1 to be injection locked. As a result of such injection locking of the first frequency tunable laser 101-1, the phase noise of the first pump optical signal 107-1 is reduced; because the phase noise of an SBS optical signal is less than the optical pump signal which generates the SBS optical signal, the phase noise of the first SBS optical signal 110-1 is also diminished due to injection locking of the first frequency tunable laser 101-1.

Because the third carrier wave frequency of the first SBS optical signal 110-1 and the fourth carrier wave frequency of the second SBS optical signal 110-2 are not within the passband 102-1-1, e.g., not equal to the center frequency thereof, of the first frequency tunable optical filter 102-1, the first SBS optical signal 110-1 and the second SBS optical signal 110-2 are reflected (or emitted) from, e.g., the third port P3-1 of, the first frequency tunable optical filter 102-1 to the optical mixer 105. Optionally, the first frequency tunable optical filter 102-1, e.g., the third port P3-1 thereof, is optically coupled to the optical mixer 105 by optical waveguide, e.g., optical fiber or planar optical waveguide.

The optical mixer 105 is configured to mix the first SBS optical signal 110-1 and the second SBS optical signal 110-2, and to generate mixing products (including a desired mixing product) each of whose frequency is a function of the third carrier wave frequency f3 and the fourth carrier wave f4 frequency. Optionally, the optical mixer 105 is an optical detector, e.g., a photodiode.

Optionally, the RF synthesizer 100 includes the RF filter 112 optically coupled to, e.g., the third port P3-1 of, the first frequency tunable optical filter 102-1. The optional RF filter 112 is configured to (a) suppress undesired mixing products at a higher frequency than the mixing product at frequency which is a difference, i.e., an absolute value of the difference, between the third carrier wave frequency and the fourth carrier wave frequency and/or (b) suppress a direct current (DC) component generated by the optical mixer 105. The desired mixing product at a frequency which (a) is the difference, i.e., the absolute value of difference, between the third carrier wave frequency and the fourth carrier wave frequency and (b) is the desired frequency 106-2 of the RF signal 114.

Suppressing of the undesired mixing products specified in (a) requires low pass filtering which can be provided by the optional RF filter 112. Some optical mixers, such as an optical detector, inherently exhibit such low pass filtering described above, and the optional RF filter 112 need not be used to provide such low pass filtering.

If the optical mixer generates a direct current (DC) component which must be suppressed and high pass filtering is not subsequently provided by other component(s) coupled to an output 114-1 of the RF synthesizer 100, then the optional RF filter 112 must provide high pass filtering to reject such DC component. Optionally, the corner frequency of the high pass filter is at or below a lowest specified frequency of the RF signal emitted by the RF synthesizer 100. Optionally, the optional RF filter 112 may be designed to suppress any signal from DC to a frequency at or below the lowest frequency of the set. Optionally, if both the low pass and high pass filtering are needed, the optional RF filter 112 may be implemented as a bandpass filter which exhibits the characteristics of both low pass filtering and high pass filtering. The mixing product at the desired frequency is passed by such band, high, and/or low pass filtering. Either the optical mixer 105 or the optional RF filter 112 (if used) is configured to provide an output 114-1 which outputs, from the RF synthesizer 100, the RF signal (or output RF signal) 114 at the desired frequency 106-2.

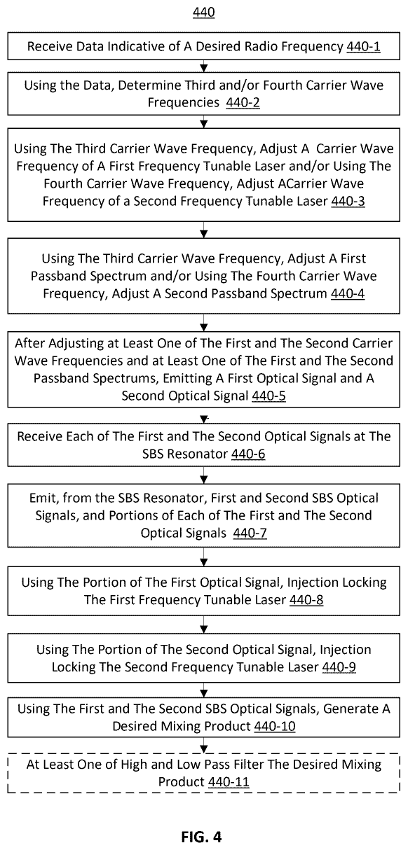

FIG. 4 illustrates one embodiment of a method 440 of generating a radio frequency signal with diminished phase noise at a desired frequency. To the extent that the methods shown in any Figures are described herein as being implemented with any of the apparatuses illustrated herein, it is to be understood that other embodiments can be implemented in other ways. Optionally, the methods herein may be implemented by the apparatuses described with respect to FIGS. 1A-3 and 5. Techniques described with respect to any of FIGS. 1A-3 and 5 may be applicable to the methods herein. Techniques described with respect to the methods herein may be application to the apparatuses and techniques described therefore in any of FIGS. 1A-3 and 5.

The blocks of the flow diagrams have been arranged in a generally sequential manner for ease of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner).

In block 440-1, data indicative of a desired frequency of an RF signal (configured to be emitted) is received. Optionally, such data is received by an RF synthesizer, e.g., the processing system or a data input thereof, where the RF synthesizer is configured to emit the RF signal.

In block 440-2, using the data indicative of the desired frequency, a third carrier wave frequency and a fourth carrier wave frequency whose desired mixing product, e.g., absolute value thereof, would result in generating a radio frequency signal at the desired frequency, are determined. The third carrier wave frequency is of a first SBS optical signal configured to be generated in the SBS optical resonator. The fourth carrier wave frequency is of a second SBS optical signal configured to be generated in the SBS optical resonator. Such carrier wave frequencies and SBS optical signals are described further elsewhere herein. Optionally, the third carrier wave frequency and the fourth carrier wave frequency are each selected from one of the trio relationships described elsewhere herein. Optionally, the third carrier wave frequency and the fourth carrier wave frequency are each selected from a set, of SBS optical frequencies which the SBS optical resonator is configured to generate, or a representation of the set, e.g., stored in a processing system (for example in translational data stored therein). Optionally, the set of SBS optical frequencies comprises all possible SBS optical signal carrier wave frequencies which can be generated by the SBS optical resonator.

In block 440-3, using the determined third carrier wave frequency, a carrier wave frequency, of a first optical signal configured to be emitted by a first frequency tunable laser, is adjusted to be a first carrier wave frequency, e.g., by adjusting a temperature of the first tunable frequency laser and/or using the determined fourth carrier wave frequency, a carrier wave frequency, of a second optical signal configured to be emitted by a second frequency tunable laser, is adjusted to be a second carrier wave frequency, e.g., by adjusting a temperature of the second tunable frequency laser. Thus, optionally, using the determined third carrier wave frequency, a temperature of the first frequency tunable laser may be adjusted by heating and/or cooling so that a first optical signal configured to be emitted by the first frequency tunable laser has the first carrier wave frequency and/or using the determined fourth carrier wave frequency, a temperature of the second frequency tunable laser may be adjusted by heating and/or cooling so that a second optical signal configured to be emitted by the second frequency tunable laser, has the second carrier wave frequency.

Optionally, each temperature adjustments may be facilitated by having the processing system emit a control signal to a heater and/or cooler, where a parameter value of the control signal causes the heater and/or cooler to adjust the temperature of a frequency tunable laser to emit an optical signal with the first or the second carrier wave frequency. Techniques for doing so are described elsewhere herein. Optionally, a set of pairs, of a first carrier wave frequency and a corresponding temperature of the first tunable laser needed to obtain such first carrier wave frequency in a first optical signal emitted from the first tunable laser, is stored in the processing system, e.g., the translational data thereof. Optionally, a set of pairs, of a second carrier wave frequency and a corresponding temperature of the second tunable laser needed to obtain such second carrier wave frequency in a second optical signal emitted from the second tunable laser, is stored in the processing system, e.g., the translational data thereof. Such techniques are further described elsewhere herein. Optionally, each of the carrier wave frequency adjustments is facilitated using a control signal parameter value of a trio relationship described elsewhere herein

In block 440-4, using the third carrier wave frequency, a first passband spectrum, for example, a center frequency thereof, e.g., of a first tunable optical filter, is adjusted (e.g., by adjusting the temperature of the first tunable optical filter) to include the first carrier wave frequency and/or using the fourth carrier wave frequency, a second passband spectrum, for example, a center frequency thereof, e.g., of a second tunable optical filter, is adjusted (e.g., by adjusting the a temperature of the second tunable optical filter) to include to the second carrier wave frequency. Optionally, each temperature adjustments may be facilitated by having the processing system emit a control signal to a heater and/or cooler, where the control signal causes the heater and/or cooler to adjust the temperature of a frequency tunable optical filter to cause the frequency tunable optical filter to have a passband, or a center frequency thereof, at the first or the second carrier wave frequency. Techniques for doing so are described elsewhere herein. Optionally, a set of pairs, of a first carrier wave frequency and a corresponding temperature of the first tunable optical filter needed to obtain a first passband spectrum, or a center frequency thereof, of the first frequency tunable optical filter at the first carrier wave frequency, is stored in the processing system, e.g., the translational data thereof. Optionally, a set of pairs, of a second carrier wave frequency and a corresponding temperature of the second tunable optical filter needed to obtain a second passband spectrum, or a center frequency thereof, of the second frequency tunable optical filter at the second carrier wave frequency, is stored in the processing system, e.g., the translational data thereof. Optionally, each of the passband spectrum adjustments is facilitated using a control signal parameter value of a trio relationship described elsewhere herein

In block 440-5, after adjusting a at least one of the first and the second carrier wave frequencies and after adjusting at least one of the first and the second passband spectrums, a first optical signal having a first carrier wave frequency is emitted from the first frequency tunable laser, and a second optical signal having a second carrier wave frequency is emitted from the second frequency tunable laser. As further discussed elsewhere herein, because the first carrier wave frequency is substantially within the first passband spectrum, e.g., substantially equal to the center frequency of the first passband spectrum, of the first frequency tunable optical filter, the first optical signal propagates through the first frequency tunable optical filter. As further discussed elsewhere herein, because the second passband spectrum, e.g., the center frequency thereof, of the second frequency tunable optical filter is substantially equal to the second carrier wave frequency, the second optical signal propagates through the first frequency tunable optical filter.

In block 440-6, an SBS optical resonator receives through the first passband spectrum the first optical signal and through the second passband spectrum the second optical signals. Optionally, thus, the first optical signal is passed through, e.g., filtered by, the first tunable optical filter, and the second optical signal is passed through, e.g., filtered by, the second tunable optical filter.

In block 440-7, first and second SBS optical signals, a portion of the first optical signal, and a portion of the second optical signal are emitted from the SBS optical resonator. The first SBS optical signal has a third carrier wave frequency further described elsewhere herein. The second SBS optical signal has a fourth carrier wave frequency described elsewhere herein. Optionally, each of the first and the second SBS optical signals are generated in the SBS optical resonator as described elsewhere herein. Optionally, each of the portion of the first optical signal and the portion of the second optical signal are generated, e.g., reflected, in the SBS optical resonator as described elsewhere herein. Generation of each of the SBS optical signals and the portions is further described elsewhere herein.

In block 440-8, the portion of the first optical signal is received through the first passband spectrum and at the first frequency tunable laser injection locking the first frequency tunable laser. In block 440-9, the portion of the second optical signal is received through the second passband spectrum and at the second frequency tunable laser injection locking the second frequency tunable laser.

In block 440-10, using the first and the second SBS optical signals, a desired mixing product, of the first and the second SBS optical signals, is generated at a frequency which (a) is the difference, i.e., the absolute value of difference, between the third carrier wave frequency and the fourth carrier wave frequency and (b) is the desired frequency 106-2 of the RF signal. Optionally, the desired mixing product is generated by mixing the first and the second SBS optical signals in an optical mixer as described elsewhere herein. Optionally, when the desired mixing product is generated, undesired mixing products and/or a direct current component may be generated, e.g., by the optical mixer.

In optional block 440-11, at least one of: (a) low pass filter the mixing product to suppress the undesired mixing products at a higher frequency than the desired mixing product and (b) high pass filter the desired mixing product to suppress the direct current (DC) component. The desired mixing product at the desired frequency is passed by such high and low pass filtering. Such optional high and low pass filtering is further described elsewhere herein.

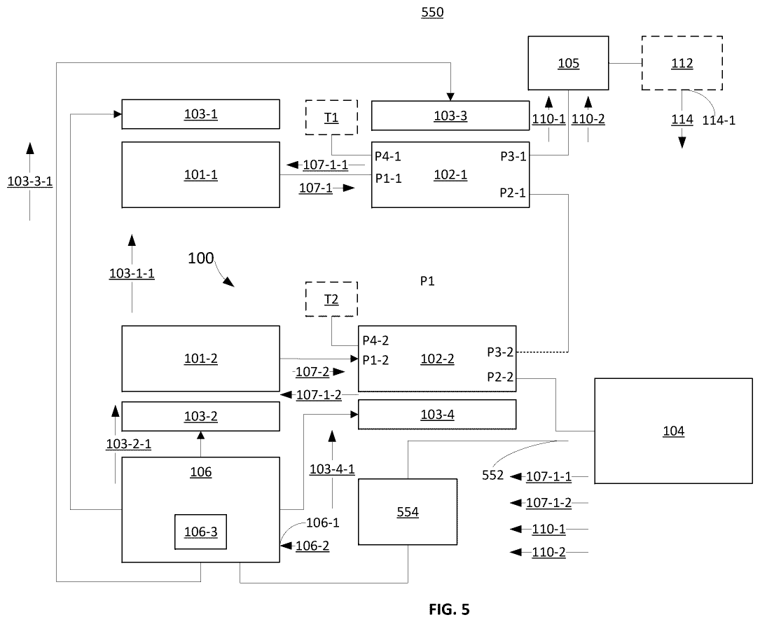

FIG. 5 illustrates a block diagram of one embodiment of an apparatus 550 to calibrate a radio frequency synthesizer 100. To facilitate use of embodiments of the RF synthesizer 100, optionally the RF synthesizer 100 is calibrated prior to use. The apparatus 550 includes the RF synthesizer 100, a circuit 554 configured to ascertain a carrier wave frequency of optical spectral component(s) emitted from the SBS optical resonator 104, e.g., the first and the second SBS optical signals 110-1, 110-2 and a power level or energy level of such optical spectral component(s), and optionally an optical coupler 552.

The circuit 554, configured to ascertain frequency of optical spectral component(s) and a power level or energy level of such optical spectral component(s), may be an optical spectrum analyzer, a frequency counter, an optical power meter, and optionally a tunable optical filter, or any other circuit capable of performing the aforementioned function. The circuit 554 is configured to ascertain a frequency and a power or an energy level of each spectral component emitted from the SBS optical resonator 104. The circuit 554 is further configured to convey such data to the processing system 106.

The optional optical coupler 552 configured to optically couple the optical spectral component(s) emitted from the SBS optical resonator to the circuit 554. Although the optional optical coupler 552 is illustrated as being inserted between the SBS optical resonator 104 and the first frequency tunable optical filter, e.g., the second port P2-2 thereof, the optional optical coupler 552 is not necessary. In lieu of the optional optical coupler 552, the circuit 554, configured to ascertain frequency of an optional optical spectral component(s) and a power level or energy level of such optical spectral component(s), may be optically connected to a second port, e.g., the second coupling port 332-2 illustrated in FIG. 3, of the SBS optical resonator 104.

Calibration entails ascertaining (a) a first trio relationship of a parameter value of each of the first control signal 103-1-1 and the third control signal 103-3-1, and a third carrier wave frequency of a first SBS optical signal configured to be emitted by the SBS optical resonator when such parameter value of the first control signal is conveyed to the first frequency tunable laser and when such parameter value of the third control signal is conveyed to the first frequency tunable optical filter, and (b) a second trio relationship of a parameter value of each of the second control signal 103-3-1 and the fourth control signal 103-4-1, and a fourth carrier wave frequency of a second SBS optical signal configured to be emitted by the SBS optical resonator when such parameter value of the second control signal is conveyed to the second frequency tunable laser and when such parameter value of the fourth control signal is conveyed to the second frequency tunable optical filter. Optionally, one or both of the first and second sets of trios may each be represented by an equation, e.g., fit by the processing system 106 using a corresponding set of trios. The sets of trios, and each of their alternative representations, are further described elsewhere herein.

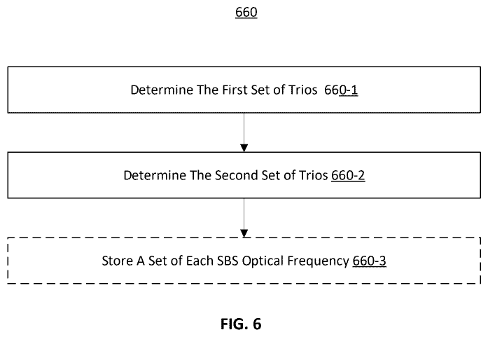

FIG. 6 illustrates one embodiment of a method 660 of calibrating a radio frequency synthesizer according to embodiments of the invention. Optionally, such method 660 may be performed by the processing system 106 of the RF synthesizer 100 or an external processing system.

In block 660-1, a first trio relationship (described above) is determined. Optionally, such determination can be facilitated by a processing system adjusting, e.g., using conventional optimization and/or search algorithm(s), the parameter value of each of the first control signal and the third control signal, to obtain different discrete combinations of parameter values of the first and the third control signals which generate different SBS optical signals to be emitted from the SBS optical resonator. Each SBS optical signal can be differentiated from an optical signal (emitted by a frequency tunable laser and from which the SBS optical signal is derived in the SBS optical resonator) because the SBS optical signal is at a lower frequency than the optical signal emitted by the frequency tunable laser.

In block 660-2, the second trio relationship (described above) is determined. Optionally, such determination can be facilitated by a processing system adjusting, e.g., using conventional optimization and/or search algorithm(s), the parameter value of each of the second control signal and the fourth control signal, to obtain different discrete combinations of parameter values of the first and the third control signals which generate different SBS optical signals to be emitted from the SBS optical resonator. In optional block 660-3, each of the first and the second trio relationship is stored, e.g., in the processing system, for example, in the translational data.

While the present teachings have been illustrated with respect to one or more implementations, alterations and/or modifications can be made to the illustrated examples without departing from the scope of the appended claims. In addition, while a particular feature of the present disclosure may have been described with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and/or the claims, such terms are intended to be inclusive in a manner similar to the term “comprising.” The term “at least one of” is used to mean one or more of the listed items can be selected. As used herein, the term “one or more of” with respect to a listing of items such as, for example, A and B or A and/or B, means A alone, B alone, or A and B. The term “at least one of” is used to mean one or more of the listed items can be selected.

Terms of relative position as used in this application are defined based on a plane parallel to the conventional plane or working surface of a material (e.g., a layer or a substrate), regardless of orientation. Terms such as “on,” “higher,” “lower,” “over,” “top,” and “under” are defined with respect to the conventional plane or working surface being on the top surface of a layer or substrate, regardless of orientation. The terms “about” or “substantially” indicate that the value or parameter specified may be somewhat altered, as long as the alteration does not result in nonconformance of the process or structure to the illustrated embodiment. Finally, “exemplary” indicates the description is used as an example, rather than implying that it is an ideal. Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

The processing system may optionally be implemented by processor circuitry communicatively coupled to memory circuitry. The processor circuitry described herein may include one or more microprocessors, microcontrollers, digital signal processing (DSP) elements, application-specific integrated circuits (ASICs), and/or field programmable gate arrays (FPGAs). In this exemplary embodiment, processor circuitry includes or functions with software programs, firmware, or other computer readable instructions for carrying out various process tasks, calculations, and control functions, used in the methods described herein. These instructions are typically tangibly embodied on any storage media (or computer readable medium) used for storage of computer readable instructions or data structures.

The memory circuitry described herein can be implemented with any available storage media (or computer readable medium) that can be accessed by a general purpose or special purpose computer or processor, or any programmable logic device. Suitable computer readable medium may include storage or memory media such as semiconductor, magnetic, and/or optical media. For example, computer readable media may include conventional hard disks, Compact Disk-Read Only Memory (CD-ROM), DVDs, volatile or non-volatile media such as Random Access Memory (RAM) (including, but not limited to, Dynamic Random Access Memory (DRAM)), Read Only Memory (ROM), Electrically Erasable Programmable ROM (EEPROM), and/or flash memory. Combinations of the above are also included within the scope of computer readable media.

Methods of the invention can be implemented in computer readable instructions, such as program modules or applications, which may be stored in the computer readable medium that is part of (optionally the memory circuitry) or communicatively coupled to the processing circuitry, and executed by the processing circuitry, optionally the processor circuitry. Generally, program modules or applications include routines, programs, objects, data components, data structures, algorithms, and the like, which perform particular tasks or implement particular abstract data types.

### EXEMPLARY EMBODIMENTS

Example 1 includes a method for generating a desired frequency of a radio frequency (RF) signal with diminished phase noise, the method comprising: receiving data indicative of the desired frequency of the RF signal; using the data indicative of the desired frequency, determining a third carrier wave frequency and a fourth carrier wave frequency which when mixed generate a mixing product at the desired frequency, wherein each of the third and the fourth carrier wave frequencies is selected from a set of stimulated Brillouin scattering (SBS) optical frequencies at which an SBS optical resonator is configured to generate an optical signal; using the third carrier wave frequency, adjusting a carrier wave frequency of a first optical signal, configured to be emitted by a first frequency tunable laser, to be a first carrier wave frequency and/or using the fourth carrier wave frequency, adjusting a carrier wave frequency of a second optical signal, configured to be emitted by a second frequency tunable laser, to be equal to a second carrier wave frequency; using the third carrier wave frequency, adjusting a first passband spectrum to include the first carrier wave frequency and/or using the fourth carrier wave frequency, adjusting a second passband spectrum to include the second carrier wave frequency; after adjusting the first carrier wave frequency and/or the second carrier wave frequency, and after adjusting the first passband spectrum and/or after adjusting the second passband spectrum, then emitting the first optical signal with the first carrier wave frequency from the first frequency tunable laser and emitting the second optical signal with the second carrier wave frequency from the second frequency tunable laser; receiving, at the SBS optical resonator, the first optical signal through the first passband spectrum and the second optical signal through the second passband spectrum; emitting from the SBS optical resonator, a first SBS optical signal, a second SBS optical signal, a portion of the first optical signal, and a portion of the second optical signal; receiving, the portion of the first optical signal, through the first passband spectrum and at the first frequency tunable laser injection locking the first frequency tunable laser; receiving, the portion of the second optical signal, through the second passband spectrum and at the second frequency tunable laser injection locking the second frequency tunable laser; and using the first SBS optical signal and the second SBS optical signal, generating the mixing product at the desired frequency.

Example 2 includes the method of Example 1, further comprising at least one of: high pass filtering the mixing product at the desired frequency to suppress a direct current component and low pass filtering the mixing product at the desired frequency to suppress undesired mixing products at frequencies higher than the desired frequency.

Example 3 includes the method of any of Examples 1-2, wherein adjusting the first carrier wave frequency comprises varying a temperature of the first frequency tunable laser; and wherein adjusting the second carrier wave frequency comprises varying a temperature of the second frequency tunable laser.

Example 4 includes the method of any of Examples 1-3, wherein adjusting the first passband spectrum comprises varying a temperature of a first frequency tunable optical filter having the first passband spectrum; and wherein adjusting the second passband spectrum comprises varying a temperature of a second frequency tunable optical filter having the second passband spectrum.

Example 5 includes the method of any of Examples 1-4, wherein the portion of the first optical signal is optically coupled through a first frequency tunable optical filter having the first passband spectrum to the first frequency tunable laser; and wherein the portion of the second optical signal is optically coupled through a second frequency tunable optical filter having the second passband spectrum to the second frequency tunable laser.

Example 6 includes the method of any of Examples 1-5, wherein the third carrier wave frequency is selected from a first or a second trio relationship and the fourth carrier wave frequency is selected from the first or the second trio relationship; wherein using the third carrier wave frequency, adjusting the carrier wave frequency of the first optical signal comprises using a parameter value of a first control signal to adjust the carrier wave frequency of the first optical signal; wherein using the fourth carrier wave frequency, adjusting the carrier wave frequency of the first optical signal comprises using a parameter value of a second control signal to adjust the carrier wave frequency of the second frequency tunable laser; wherein using the third carrier wave frequency, adjusting the first passband spectrum comprises using a parameter value of a third control signal to adjust the first passband spectrum of a first frequency tunable optical filter; wherein using the fourth carrier wave frequency, adjusting the second passband spectrum comprises using a parameter value of a fourth control signal to adjust the second passband spectrum of a second frequency tunable optical filter; wherein the first trio relationship includes a parameter value of each of the first control signal and the third control signal, and a third carrier wave frequency of a first SBS optical signal configured to be emitted by the SBS optical resonator when such parameter value of the first control signal is conveyed to the first frequency tunable laser and when such parameter value of the third control signal is conveyed to the first frequency tunable optical filter; and wherein the second trio relationship includes a parameter value of each of the second control signal and the fourth control signal, and a fourth carrier wave frequency of a second SBS optical signal configured to be emitted by the SBS optical resonator when such parameter value of the second control signal is conveyed to the second frequency tunable laser and when such parameter value of the fourth control signal is conveyed to the second frequency tunable optical filter.

Example 7 includes a radio frequency (RF) synthesizer configured to generate a desired frequency of an RF signal with diminished phase noise, the RF synthesizer comprising: a processing circuit configured to receive data indicative of the desired frequency of the RF signal, to determine a third carrier wave frequency and a fourth carrier wave frequency which when mixed generate a mixing product at the desired frequency, using the third carrier wave frequency, to generate a first control signal with a parameter value and a third control signal with a parameter value, and using the fourth carrier wave frequency, to generate a second control signal with a parameter value and a fourth control signal with a parameter value, wherein each of the third and the fourth carrier wave frequencies is selected from a set of stimulated Brillouin scattering (SBS) optical frequencies at which an SBS optical resonator is configured to generate an optical signal; a first frequency tunable laser configured to emit a first optical signal at a first carrier wave frequency determined by the parameter value of the first control signal; a second frequency tunable laser configured to emit a second optical signal, at a second carrier wave frequency determined by the parameter value of the second control signal; a first frequency tunable optical filter configured to receive the first optical signal, wherein a first passband spectrum of the first frequency tunable optical filter is configured to be set, by the parameter value of the third control signal, to include the first carrier wave frequency; a second frequency tunable optical filter configured to receive the second optical signal, wherein a second passband spectrum of the second frequency tunable optical filter is configured to be set, by the parameter value of the fourth control signal, to include the second carrier wave frequency; the SBS optical resonator configured to receive the first optical signal having the first carrier wave frequency and the second optical signal having the second carrier wave frequency and to emit a portion of the first optical signal having the first carrier wave frequency, a portion of the second optical signal having the second carrier wave frequency, a first SBS optical signal having the third carrier wave frequency, and a second SBS optical signal having the fourth carrier wave frequency; wherein the first frequency tunable laser is further configured to receive, through the first frequency tunable optical filter, the portion of the first optical signal having the first carrier wave frequency and to be injection locked; wherein the second frequency tunable laser is further configured to receive, through the second frequency tunable optical filter, the portion of the second optical signal having the second carrier wave frequency and to be injection locked; and an optical mixer configured to generate, using the first SBS optical signal and the second SBS optical signal, generating the mixing product at the desired frequency.

Example 8 includes the RF synthesizer of Example 7, further comprising a filter circuit electrically coupled to the optical mixer and configured to high pass filter the mixing product at the desired frequency to remove a direct current component and/or low pass filter the mixing product at the desired frequency to suppress undesired mixing products at frequencies higher than the desired frequency.

Example 9 includes the RF synthesizer of any of Examples 7-8, further comprising a first heater and/or cooler configured to change a temperature of the first frequency tunable laser and to receive the first control signal; a second heater and/or cooler configured to change a temperature of the second frequency tunable laser and to receive the second control signal; a third heater and/or cooler configured to change a temperature of the first frequency tunable optical filter and configured to receive the third control signal; and a fourth heater and/or cooler configured to change a temperature of the second frequency tunable optical filter and to receive the fourth control signal.

Example 10 includes the RF synthesizer of any of Examples 7-9, wherein the first frequency tunable optical filter is a first frequency tunable four port optical filter comprising a first port, a second port, a third port, and a fourth port; wherein the second frequency tunable optical filter is a second frequency tunable four port optical filter comprising a first port, a second port, a third port, and a fourth port; wherein the first port of the first frequency tunable four port optical filter is configured to receive the first optical signal from the first frequency tunable laser and to provide the portion of the first optical signal to the first frequency tunable laser, wherein the second port of the first frequency tunable four port optical filter is configured to emit the first optical signal to the third port of the second frequency tunable optical filter and to receive the portion of the first optical signal, the first SBS optical signal, and the second SBS optical signal from the third port of the second frequency tunable optical filter, and wherein the third port of the first frequency tunable four port optical filter is configured to emit the first and the second SBS optical signals to the optical mixer; wherein the first port of the second frequency tunable four port optical filter is configured to receive the second optical signal from the second frequency tunable laser and to provide the portion of the second optical signal to the second frequency tunable laser, wherein the second port of the second frequency tunable four port optical filter is configured to emit the first optical signal and the second optical signal to the SBS optical resonator and to receive the portion of the first optical signal, the portion of the second optical signal, the first SBS optical signal, and the second SBS optical signal from the SBS optical resonator, and wherein the third port of the second frequency tunable four port optical filter is configured to emit the portion of the first optical signal and the first and the second SBS optical signals to the optical mixer.

Example 11 includes the RF synthesizer of Example 10, wherein each of the first and/or the second frequency tunable four port optical filters comprises: a first planar optical waveguide on a substrate and including a first portion optically coupled to a second portion, wherein each portion of the first planar optical waveguide includes a first sidewall and a second sidewall each with a periodic grating therein, wherein there is a one hundred and eighty degree shift in a phase of the periodic grating where the first and the second portions, of the first planar optical waveguide, adjoin; and a second planar optical waveguide on the substrate and including a first portion optically coupled to a second portion, wherein each portion of the second planar optical waveguide includes a first sidewall and a second sidewall each with a periodic grating therein, wherein there is a one hundred and eighty degree shift in a phase of the periodic grating where the first and the second portions, of the second planar optical waveguide, adjoin.

Example 12 includes the RF synthesizer of any of Examples 7-11, wherein the processing circuit is configured to store a first trio relationship and a second trio relationship; wherein the third carrier wave frequency is selected from the first or the second trio relationship and the fourth carrier wave frequency is selected from the first or the second trio relationship; wherein the first trio relationship includes a parameter value of each of the first control signal and the third control signal, and the third carrier wave frequency of the first SBS optical signal configured to be emitted by the SBS optical resonator when such parameter value of the first control signal is conveyed to the first frequency tunable laser and when such parameter value of the third control signal is conveyed to the first frequency tunable optical filter; and wherein the second trio relationship includes a parameter value of each of the second control signal and the fourth control signal, and the fourth carrier wave frequency of the second SBS optical signal configured to be emitted by the SBS optical resonator when such parameter value of the second control signal is conveyed to the second frequency tunable laser and when such parameter value of the fourth control signal is conveyed to the second frequency tunable optical filter.

Example 13 includes the RF synthesizer of any of Examples 7-12, further comprising a first circuit optically coupled to the processing circuit and configured to ascertain a carrier wave frequency, and a power or an energy level, of the first SBS optical signal and the second SBS optical signal; and wherein the processing circuit is further configured to generate a first trio relationship between the third carrier wave frequency of the first SBS optical signal, the parameter value of the first control signal, and the parameter value of the third control signal, and to generate a second trio relationship between the fourth carrier wave frequency of the second SBS optical signal, the parameter value of the second control signal, and the parameter value of the fourth control signal.

Example 14 includes the RF synthesizer of Example 13, wherein the processing circuit is further configured to store the first and the second trio relationships.

Example 15 includes the RF synthesizer of any of Examples 7-14, wherein the first frequency tunable optical filter, the second frequency tunable optical filter circuit, the first frequency tunable laser, the second frequency tunable laser, the processing circuit, the SBS optical resonator, and/or the optical mixer are each on a substrate.

Example 16 includes the RF synthesizer of Example 15, wherein a first heater and/or cooler configured to receive the first control signal, a second heater and/or cooler configured to receive the second control signal, a third heater and/or cooler configured to receive the third control signal, and/or a fourth heater and/or cooler configured to receive the fourth control signal are each on a substrate.

Example 17 includes the RF synthesizer of Example 16, further comprising a filter circuit on the substrate and electrically coupled to the optical mixer and configured to high pass filter the mixing product at the desired frequency to suppress a direct current component and/or low pass filter the mixing product at the desired frequency to suppress undesired mixing products at frequencies higher than the desired frequency.

Example 18 includes the RF synthesizer of any of Examples 7-17, wherein each of the first and the second frequency tunable optical filters, and the SBS optical resonator, include planar optical waveguide on a substrate.

Example 19 includes the RF synthesizer of any of Examples 7-18, wherein the SBS optical resonator comprises an optical waveguide optically configured to receive the first and the second optical signals, and to emit the portion of the first optical signal, the portion of the second optical signal, the first SBS optical signal, and the second SBS optical signal; and an optical resonator consisting of one of a disc resonator, an optical waveguide resonator, a race track resonator, a ring resonator, and an oval resonator.

Example 20 includes a method of calibrating a radio frequency (RF) signal which includes a processing circuit configured to receive data indicative of a desired frequency of the RF signal, to determine a third carrier wave frequency and a fourth carrier wave frequency which when mixed generate a mixing product at the desired frequency, using the third carrier wave frequency, to generate a first control signal with a parameter value and a third control signal with a parameter value, and using the fourth carrier wave frequency, to generate a second control signal with a parameter value and a fourth control signal with a parameter value, wherein each of the third and the fourth carrier wave frequencies is selected from a set of stimulated Brillouin scattering (SBS) optical frequencies at which an SBS optical resonator is configured to generate an optical signal; a first frequency tunable laser configured to emit a first optical signal at a first carrier wave frequency determined by the parameter value of the first control signal; a second frequency tunable laser configured to emit a second optical signal, at a second carrier wave frequency determined by the parameter value of the second control signal; a first frequency tunable optical filter configured to receive the first optical signal, wherein a first passband spectrum of the first frequency tunable optical filter is configured to be set, by the parameter value of the third control signal, to include the first carrier wave frequency; a second frequency tunable optical filter configured to receive the second optical signal, wherein a second passband spectrum of the second frequency tunable optical filter is configured to be set, by the parameter value of the fourth control signal, to include the second carrier wave frequency; the SBS optical resonator configured to receive the first optical signal having the first carrier wave frequency and the second optical signal having the second carrier wave frequency and to emit a portion of the first optical signal having the first carrier wave frequency, a portion of the second optical signal having the second carrier wave frequency, a first SBS optical signal having the third carrier wave frequency, and a second SBS optical signal having the fourth carrier wave frequency; wherein the first frequency tunable laser is further configured to receive, through the first frequency tunable optical filter, the portion of the first optical signal having the first carrier wave frequency and to be injection locked; wherein the second frequency tunable laser is further configured to receive, through the second frequency tunable optical filter, the portion of the second optical signal having the second carrier wave frequency and to be injection locked; and an optical mixer configured to generate, using the first SBS optical signal and the second SBS optical signal, generating the mixing product at the desired frequency, the method comprising: determining a first trio relationship; determining a second trio relationship; storing the first and the second trio relationships; and wherein the first trio relationship includes a parameter value of each of the first control signal and the third control signal, and the third carrier wave frequency of the first SBS optical signal configured to be emitted by the SBS optical resonator when such parameter value of the first control signal is conveyed to the first frequency tunable laser and when such parameter value of the third control signal is conveyed to the first frequency tunable optical filter; wherein the second trio relationship includes a parameter value of each of the second control signal and the fourth control signal, and the fourth carrier wave frequency of the second SBS optical signal configured to be emitted by the SBS optical resonator when such parameter value of the second control signal is conveyed to the second frequency tunable laser and when such parameter value of the fourth control signal is conveyed to the second frequency tunable optical filter.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A method for generating a desired frequency of a radio frequency (RF) signal with diminished phase noise, the method comprising:
receiving data indicative of the desired frequency of the RF signal;
using the data indicative of the desired frequency, determining a third carrier wave frequency and a fourth carrier wave frequency which when mixed generate a mixing product at the desired frequency, wherein each of the third and the fourth carrier wave frequencies is selected from a set of stimulated Brillouin scattering (SBS) optical frequencies at which an SBS optical resonator is configured to generate an optical signal;
using the third carrier wave frequency, adjusting a carrier wave frequency of a first optical signal, configured to be emitted by a first frequency tunable laser, to be a first carrier wave frequency and/or using the fourth carrier wave frequency, adjusting a carrier wave frequency of a second optical signal, configured to be emitted by a second frequency tunable laser, to be equal to a second carrier wave frequency;
using the third carrier wave frequency, adjusting a first passband spectrum to include the first carrier wave frequency and/or using the fourth carrier wave frequency, adjusting a second passband spectrum to include the second carrier wave frequency;
after adjusting the first carrier wave frequency and/or the second carrier wave frequency, and after adjusting the first passband spectrum and/or after adjusting the second passband spectrum, then emitting the first optical signal with the first carrier wave frequency from the first frequency tunable laser and emitting the second optical signal with the second carrier wave frequency from the second frequency tunable laser;
receiving, at the SBS optical resonator, the first optical signal through the first passband spectrum and the second optical signal through the second passband spectrum;
emitting from the SBS optical resonator, a first SBS optical signal, a second SBS optical signal, a portion of the first optical signal, and a portion of the second optical signal;
receiving, the portion of the first optical signal, through the first passband spectrum and at the first frequency tunable laser injection locking the first frequency tunable laser;
receiving, the portion of the second optical signal, through the second passband spectrum and at the second frequency tunable laser injection locking the second frequency tunable laser; and
using the first SBS optical signal and the second SBS optical signal, generating the mixing product at the desired frequency.

2. The method of claim 1, further comprising at least one of: high pass filtering the mixing product at the desired frequency to suppress a direct current component and low pass filtering the mixing product at the desired frequency to suppress undesired mixing products at frequencies higher than the desired frequency.

3. The method of claim 1, wherein adjusting the first carrier wave frequency comprises varying a temperature of the first frequency tunable laser; and
wherein adjusting the second carrier wave frequency comprises varying a temperature of the second frequency tunable laser.

4. The method of claim 1, wherein adjusting the first passband spectrum comprises varying a temperature of a first frequency tunable optical filter having the first passband spectrum; and
wherein adjusting the second passband spectrum comprises varying a temperature of a second frequency tunable optical filter having the second passband spectrum.

5. The method of claim 1, wherein the portion of the first optical signal is optically coupled through a first frequency tunable optical filter having the first passband spectrum to the first frequency tunable laser; and
wherein the portion of the second optical signal is optically coupled through a second frequency tunable optical filter having the second passband spectrum to the second frequency tunable laser.

6. The method of claim 1, wherein the third carrier wave frequency is selected from a first or a second trio relationship and the fourth carrier wave frequency is selected from the first or the second trio relationship;
wherein using the third carrier wave frequency, adjusting the carrier wave frequency of the first optical signal comprises using a parameter value of a first control signal to adjust the carrier wave frequency of the first optical signal;
wherein using the fourth carrier wave frequency, adjusting the carrier wave frequency of the first optical signal comprises using a parameter value of a second control signal to adjust the carrier wave frequency of the second frequency tunable laser;
wherein using the third carrier wave frequency, adjusting the first passband spectrum comprises using a parameter value of a third control signal to adjust the first passband spectrum of a first frequency tunable optical filter;
wherein using the fourth carrier wave frequency, adjusting the second passband spectrum comprises using a parameter value of a fourth control signal to adjust the second passband spectrum of a second frequency tunable optical filter;
wherein the first trio relationship includes a parameter value of each of the first control signal and the third control signal, and a third carrier wave frequency of a first SBS optical signal configured to be emitted by the SBS optical resonator when such parameter value of the first control signal is conveyed to the first frequency tunable laser and when such parameter value of the third control signal is conveyed to the first frequency tunable optical filter; and
wherein the second trio relationship includes a parameter value of each of the second control signal and the fourth control signal, and a fourth carrier wave frequency of a second SBS optical signal configured to be emitted by the SBS optical resonator when such parameter value of the second control signal is conveyed to the second frequency tunable laser and when such parameter value of the fourth control signal is conveyed to the second frequency tunable optical filter.

7. A radio frequency (RF) synthesizer configured to generate a desired frequency of an RF signal with diminished phase noise, the RF synthesizer comprising:
a processing circuit configured to receive data indicative of the desired frequency of the RF signal, to determine a third carrier wave frequency and a fourth carrier wave frequency which when mixed generate a mixing product at the desired frequency, using the third carrier wave frequency, to generate a first control signal with a parameter value and a third control signal with a parameter value, and using the fourth carrier wave frequency, to generate a second control signal with a parameter value and a fourth control signal with a parameter value, wherein each of the third and the fourth carrier wave frequencies is selected from a set of stimulated Brillouin scattering (SBS) optical frequencies at which an SBS optical resonator is configured to generate an optical signal;
a first frequency tunable laser configured to emit a first optical signal at a first carrier wave frequency determined by the parameter value of the first control signal;
a second frequency tunable laser configured to emit a second optical signal, at a second carrier wave frequency determined by the parameter value of the second control signal;
a first frequency tunable optical filter configured to receive the first optical signal, wherein a first passband spectrum of the first frequency tunable optical filter is configured to be set, by the parameter value of the third control signal, to include the first carrier wave frequency;
a second frequency tunable optical filter configured to receive the second optical signal, wherein a second passband spectrum of the second frequency tunable optical filter is configured to be set, by the parameter value of the fourth control signal, to include the second carrier wave frequency;
the SBS optical resonator configured to receive the first optical signal having the first carrier wave frequency and the second optical signal having the second carrier wave frequency and to emit a portion of the first optical signal having the first carrier wave frequency, a portion of the second optical signal having the second carrier wave frequency, a first SBS optical signal having the third carrier wave frequency, and a second SBS optical signal having the fourth carrier wave frequency;
wherein the first frequency tunable laser is further configured to receive, through the first frequency tunable optical filter, the portion of the first optical signal having the first carrier wave frequency and to be injection locked;
wherein the second frequency tunable laser is further configured to receive, through the second frequency tunable optical filter, the portion of the second optical signal having the second carrier wave frequency and to be injection locked; and
an optical mixer configured to generate, using the first SBS optical signal and the second SBS optical signal, generating the mixing product at the desired frequency.

8. The RF synthesizer of claim 7, further comprising a filter circuit electrically coupled to the optical mixer and configured to high pass filter the mixing product at the desired frequency to remove a direct current component and/or low pass filter the mixing product at the desired frequency to suppress undesired mixing products at frequencies higher than the desired frequency.

9. The RF synthesizer of claim 7, further comprising a first heater and/or cooler configured to change a temperature of the first frequency tunable laser and to receive the first control signal;
a second heater and/or cooler configured to change a temperature of the second frequency tunable laser and to receive the second control signal;
a third heater and/or cooler configured to change a temperature of the first frequency tunable optical filter and configured to receive the third control signal; and
a fourth heater and/or cooler configured to change a temperature of the second frequency tunable optical filter and to receive the fourth control signal.

10. The RF synthesizer of claim 7, wherein the first frequency tunable optical filter is a first frequency tunable four port optical filter comprising a first port, a second port, a third port, and a fourth port;
wherein the second frequency tunable optical filter is a second frequency tunable four port optical filter comprising a first port, a second port, a third port, and a fourth port;
wherein the first port of the first frequency tunable four port optical filter is configured to receive the first optical signal from the first frequency tunable laser and to provide the portion of the first optical signal to the first frequency tunable laser, wherein the second port of the first frequency tunable four port optical filter is configured to emit the first optical signal to the third port of the second frequency tunable optical filter and to receive the portion of the first optical signal, the first SBS optical signal, and the second SBS optical signal from the third port of the second frequency tunable optical filter, and wherein the third port of the first frequency tunable four port optical filter is configured to emit the first and the second SBS optical signals to the optical mixer;
wherein the first port of the second frequency tunable four port optical filter is configured to receive the second optical signal from the second frequency tunable laser and to provide the portion of the second optical signal to the second frequency tunable laser, wherein the second port of the second frequency tunable four port optical filter is configured to emit the first optical signal and the second optical signal to the SBS optical resonator and to receive the portion of the first optical signal, the portion of the second optical signal, the first SBS optical signal, and the second SBS optical signal from the SBS optical resonator, and wherein the third port of the second frequency tunable four port optical filter is configured to emit the portion of the first optical signal and the first and the second SBS optical signals to the optical mixer.

11. The RF synthesizer of claim 10, wherein each of the first and/or the second frequency tunable four port optical filters comprises:
a first planar optical waveguide on a substrate and including a first portion optically coupled to a second portion, wherein each portion of the first planar optical waveguide includes a first sidewall and a second sidewall each with a periodic grating therein, wherein there is a one hundred and eighty degree shift in a phase of the periodic grating where the first and the second portions, of the first planar optical waveguide, adjoin; and
a second planar optical waveguide on the substrate and including a first portion optically coupled to a second portion, wherein each portion of the second planar optical waveguide includes a first sidewall and a second sidewall each with a periodic grating therein, wherein there is a one hundred and eighty degree shift in a phase of the periodic grating where the first and the second portions, of the second planar optical waveguide, adjoin.

12. The RF synthesizer of claim 7, wherein the processing circuit is configured to store a first trio relationship and a second trio relationship;
wherein the third carrier wave frequency is selected from the first or the second trio relationship and the fourth carrier wave frequency is selected from the first or the second trio relationship;
wherein the first trio relationship includes a parameter value of each of the first control signal and the third control signal, and the third carrier wave frequency of the first SBS optical signal configured to be emitted by the SBS optical resonator when such parameter value of the first control signal is conveyed to the first frequency tunable laser and when such parameter value of the third control signal is conveyed to the first frequency tunable optical filter; and
wherein the second trio relationship includes a parameter value of each of the second control signal and the fourth control signal, and the fourth carrier wave frequency of the second SBS optical signal configured to be emitted by the SBS optical resonator when such parameter value of the second control signal is conveyed to the second frequency tunable laser and when such parameter value of the fourth control signal is conveyed to the second frequency tunable optical filter.

13. The RF synthesizer of claim 7, further comprising a first circuit optically coupled to the processing circuit and configured to ascertain a carrier wave frequency, and a power or an energy level, of the first SBS optical signal and the second SBS optical signal; and
wherein the processing circuit is further configured to generate a first trio relationship between the third carrier wave frequency of the first SBS optical signal, the parameter value of the first control signal, and the parameter value of the third control signal, and to generate a second trio relationship between the fourth carrier wave frequency of the second SBS optical signal, the parameter value of the second control signal, and the parameter value of the fourth control signal.

14. The RF synthesizer of claim 13, wherein the processing circuit is further configured to store the first and the second trio relationships.

15. The RF synthesizer of claim 7, wherein the first frequency tunable optical filter, the second frequency tunable optical filter circuit, the first frequency tunable laser, the second frequency tunable laser, the processing circuit, the SBS optical resonator, and/or the optical mixer are each on a substrate.

16. The RF synthesizer of claim 15, wherein a first heater and/or cooler configured to receive the first control signal, a second heater and/or cooler configured to receive the second control signal, a third heater and/or cooler configured to receive the third control signal, and/or a fourth heater and/or cooler configured to receive the fourth control signal are each on a substrate.

17. The RF synthesizer of claim 16, further comprising a filter circuit on the substrate and electrically coupled to the optical mixer and configured to high pass filter the mixing product at the desired frequency to suppress a direct current component and/or low pass filter the mixing product at the desired frequency to suppress undesired mixing products at frequencies higher than the desired frequency.

18. The RF synthesizer of claim 7, wherein each of the first and the second frequency tunable optical filters, and the SBS optical resonator, include planar optical waveguide on a substrate.

19. The RF synthesizer of claim 7, wherein the SBS optical resonator comprises an optical waveguide optically configured to receive the first and the second optical signals, and to emit the portion of the first optical signal, the portion of the second optical signal, the first SBS optical signal, and the second SBS optical signal; and
an optical resonator consisting of one of a disc resonator, an optical waveguide resonator, a race track resonator, a ring resonator, and an oval resonator.

20. A method of calibrating a radio frequency (RF) signal which includes a processing circuit configured to receive data indicative of a desired frequency of the RF signal, to determine a third carrier wave frequency and a fourth carrier wave frequency which when mixed generate a mixing product at the desired frequency, using the third carrier wave frequency, to generate a first control signal with a parameter value and a third control signal with a parameter value, and using the fourth carrier wave frequency, to generate a second control signal with a parameter value and a fourth control signal with a parameter value, wherein each of the third and the fourth carrier wave frequencies is selected from a set of stimulated Brillouin scattering (SBS) optical frequencies at which an SBS optical resonator is configured to generate an optical signal; a first frequency tunable laser configured to emit a first optical signal at a first carrier wave frequency determined by the parameter value of the first control signal; a second frequency tunable laser configured to emit a second optical signal, at a second carrier wave frequency determined by the parameter value of the second control signal; a first frequency tunable optical filter configured to receive the first optical signal, wherein a first passband spectrum of the first frequency tunable optical filter is configured to be set, by the parameter value of the third control signal, to include the first carrier wave frequency; a second frequency tunable optical filter configured to receive the second optical signal, wherein a second passband spectrum of the second frequency tunable optical filter is configured to be set, by the parameter value of the fourth control signal, to include the second carrier wave frequency; the SBS optical resonator configured to receive the first optical signal having the first carrier wave frequency and the second optical signal having the second carrier wave frequency and to emit a portion of the first optical signal having the first carrier wave frequency, a portion of the second optical signal having the second carrier wave frequency, a first SBS optical signal having the third carrier wave frequency, and a second SBS optical signal having the fourth carrier wave frequency; wherein the first frequency tunable laser is further configured to receive, through the first frequency tunable optical filter, the portion of the first optical signal having the first carrier wave frequency and to be injection locked; wherein the second frequency tunable laser is further configured to receive, through the second frequency tunable optical filter, the portion of the second optical signal having the second carrier wave frequency and to be injection locked; and an optical mixer configured to generate, using the first SBS optical signal and the second SBS optical signal, generating the mixing product at the desired frequency, the method comprising:
determining a first trio relationship;
determining a second trio relationship;
storing the first and the second trio relationships; and
wherein the first trio relationship includes a parameter value of each of the first control signal and the third control signal, and the third carrier wave frequency of the first SBS optical signal configured to be emitted by the SBS optical resonator when such parameter value of the first control signal is conveyed to the first frequency tunable laser and when such parameter value of the third control signal is conveyed to the first frequency tunable optical filter;
wherein the second trio relationship includes a parameter value of each of the second control signal and the fourth control signal, and the fourth carrier wave frequency of the second SBS optical signal configured to be emitted by the SBS optical resonator when such parameter value of the second control signal is conveyed to the second frequency tunable laser and when such parameter value of the fourth control signal is conveyed to the second frequency tunable optical filter.
